(19) United States
(12) Patent Application Publication
(10) Pub. No.: US 2026/0309199 A1
(43) Pub. Date: Oct. 8, 2026

(54) METHOD FOR OBTAINING INFORMATION ON THE WEAR CONDITION OF A VEHICLE BRAKING SYSTEM

(71) Applicant: Brembo S.P.A., Curno, Bergamo (IT)

(72) Inventors: Giorgio RIVA, Milano (IT); Alex GIMONDI, Curno, Bergamo (IT); Giacomo URSO, Curno, Bergamo (IT); Roberto ARIENTI, Curno, Bergamo (IT)

(21) Appl. No.: 19/482,926

(22) PCT Filed: May 13, 2024
(86) PCT No.: PCT/IB2024/054638

§ 371 Date: Nov. 10, 2025

(30) Foreign Application Priority Data
May 15, 2023 (IT) 102023000009711

(51) Int. Cl. F16D 66/02; B60T 17/22; F16D 55/226; F16D 121/02

(52) U.S. Cl. CPC F16D 66/02; B60T 17/22; F16D 55/226; F16D 2121/02

(57) ABSTRACT

The invention relates to a method for obtaining information on the wear condition of a braking system of a vehicle. The braking system comprises:
at least one hydraulic or electro-hydraulic actuator of a disc brake,
at least one electronic processing unit connected to such at least one hydraulic or electro-hydraulic actuator for receiving data representative of a measurement of the pressure of the brake master cylinder and a measurement of the stroke of the brake master cylinder actuated by the actuator during a braking detection time interval associated with each braking event. The method comprises the steps of:
providing, to the at least one electronic processing unit, a parametric function representative of a current condition of the braking system; such a parametric function is adapted to describe a relationship between the stroke of the brake master cylinder and the braking pressure applied by the brake master cylinder, as a function of one or more coefficients;
detecting, by a supervisor block of the at least one electronic processing unit, one or more braking samples in a braking detection time interval, for enabling an estimation block of the at least one electronic processing unit following the detection of each braking sample;
receiving, by the estimation block, a first pressure measurement of the brake master cylinder and a first stroke measurement of the brake master cylinder during each braking sample of the one or more braking samples;
estimating, by the estimation block, a plurality of first parametric function coefficients associated with each braking sample based on such a first pressure measurement of the brake master cylinder and first stroke measurement of the brake master cylinder;
enabling, by the supervisor block, a filtering block of the at least one electronic processing unit at the end of the braking detection time interval;
filtering, by the filtering block, the plurality of first coefficients associated with each braking sample to generate a plurality of second filtered coefficients provided to the supervisor block;

### FIELD OF THE INVENTION

The present invention relates to the field of vehicle braking systems. In particular, the invention relates to a method for obtaining information on the wear condition of a vehicle braking system, of the type employing, for example, hydraulic actuators or electro-hydraulic actuators, according to the brake-by-wire (BBW) technology, of a disc brake, based on an estimation of the changes that a mathematical plant model representative of the braking system can undergo.

### BACKGROUND ART

As known, a mathematical model of a braking system or plant model can be defined through a parametric function f which describes a relationship between the stroke x of the brake master cylinder and the braking pressure p applied by the brake master cylinder itself, as a function of a set of coefficients. In some cases, the brake fluid temperature T can also be employed as an input variable to the braking plant model. Therefore, the aforesaid parametric function f satisfies the relationship:

$$p = f ( x , ( T ) , ϑ ) \qquad ( 1 )$$

One of the possible embodiments of the aforesaid parametric function of the plant model is of the parabolic type, such as for example:

$$p = {ϑ}_{0} + {ϑ}_{1} \cdot x + {ϑ}_{2} \cdot {x}^{2} = {ϑ}^{t} \cdot [ \begin{matrix}1 \\ x \\ {x}^{2}\end{matrix} ] \qquad ( 2 )$$

where the vector ϑ^{t} is a row vector which can be expressed by the equation:

$${ϑ}^{t} = [ {ϑ}_{0} {ϑ}_{1} {ϑ}_{2} ] \qquad ( 3 )$$

The plant model of a braking system can undergo significant changes during an endurance race due to wear of the friction material, i.e., the wear of the pads and discs of the disc brakes. The main effects determined by such a wear are:
an increase of the idle stroke of the brake master cylinder,
a change in stiffness due to increased fluid volume in the calipers.

Such a degradation reduces braking system performance, in particular in the case of a system which employs an electronically actuated brake master cylinder, according to the brake-by-wire (BBW) technology, which mainly relies on such information.

However, the aforesaid variation in the features of the plant model can be employed to provide indirect information on the wear condition of the braking system itself.

The known solutions for obtaining information on the wear of the friction material of a vehicle braking system include employing specific sensors, such as linear variable displacement transducer (LVDT) sensors, for example, which are typically mounted on the caliper.

Such sensors have the drawback of being particularly expensive and requiring the arrangement of dedicated interfaces on the caliper to be capable of working.

To the best of the Applicant's knowledge, currently there are no methodologies which allow obtaining, indirectly but with high accuracy and reliability, information representative of the wear condition of the friction material, both in the case of a braking system employing hydraulic actuators, in which the brake master cylinder is actuated by the brake pedal, and in the case of a braking system employing electro-hydraulic actuators, i.e., of the BBW type, in which the brake master cylinder is actuated electronically.

### Solution

It is an object of the present invention to devise and provide a method for obtaining information on the wear condition of a vehicle braking system by estimating the variations that a plant model of a braking system can undergo, in particular during an endurance race, which allow at least partially overcoming the limitations and drawbacks of known type solutions.

Such an object is achieved by a method for obtaining information on the wear condition of a vehicle braking system according to claim 1.

The suggested methodology allows estimating the plant model of the braking system of a vehicle based on measurements made available in the system, such as:
the pressure p of the brake master cylinder,
the stroke x of the brake master cylinder,
possibly, the temperature T of the brake fluid as well.

In particular, the suggested methodology is configured to update the plant model of the braking system during normal braking operations, without the need for special braking maneuvers, therefore it is suitable for long endurance races.

In other words, the suggested methodology allows updating the plant model representative of the braking system based on the measurement of pressure, brake master cylinder stroke, and possibly temperature. Referring to an exemplary depiction of the plant model of parabolic type, this means that starting from an initial parabola, characterized by given coefficients which geometrically correspond to a parabola with a prefixed aperture, a new parabola with new coefficients, which geometrically correspond to a parabola with a different aperture, can be associated with the braking system.

According to the type of braking system, the method of the invention allows obtaining two different information: a wear index of the system and a control adaptation.

First information or wear index is representative of percentage information on the wear condition of the friction material, based on the changes of the estimated plant model during the race. Such a wear index consists of a map which associates the stiffness change of the plant, as a function of the parabola coefficients, with the level of wear. In particular, the rigidity of the plant will be maximum in the case of no wear, while it will be minimum in the case of maximum wear.

Such first information is suitable both for a braking system employing hydraulic actuators and in the case of a braking system employing electro-hydraulic actuators, i.e., according to BBW technology.

Second information or control adaptation of the estimated plant model is used to adapt the parameters or the structure of the closed-loop pressure/torque controller.

In particular, the control adaptation consists in modifying some parameters of the electronic control unit (ECU) of the electronically controlled actuator based on these updated coefficients of the plant model.

Such second information is suitable only for the braking systems of the BBW type and is closely associated with the specific control architecture executed.

Obtaining the aforesaid wear index has the advantage that the braking system does not require the use of the expensive specific sensors mounted on the caliper, such as LVDT sensors, for example. Moreover, it is no longer required to set up interfaces of such sensors with calipers.

Moreover, in the case of braking systems which already employ caliper-mounted sensors, the suggested method allows using an additional wear estimation mode which operates in parallel with the sensors themselves, i.e., redundantly. This allows increasing the quality of information provided by the aforesaid sensors.

Obtaining the control adaptation information has the advantage of keeping the performance of the controlled actuator constant during an entire endurance race because wear can strongly affect it.

Some advantageous embodiments are the subject of the dependent claims.

### FIGURES

Further features and advantages of the system for obtaining information on the wear condition of a vehicle braking system will be apparent from the description provided below of preferred embodiments thereof, given by way of non-limiting indication, with reference to the accompanying drawings, in which:

FIG. 1 diagrammatically shows a first embodiment of a vehicle braking system, which employs hydraulic actuators, configured to implement the method according to the present invention;

FIG. 2 diagrammatically shows a second embodiment of a vehicle braking system, which employs hydraulic actuators, configured to implement the method according to the present invention;

FIG. 3 diagrammatically shows a third embodiment of a vehicle braking system, which employs hydraulic actuators, configured to implement the method according to the present invention;

FIG. 4 diagrammatically shows a fourth embodiment of a vehicle braking system, which employs electro-hydraulic actuators, configured to implement the method according to the present invention;

FIG. 5 shows, by means of a block diagram, the functions implemented by an electronic control unit of the braking system in FIG. 4;

FIG. 6 shows, by means of a flowchart, the operating steps of the general method for obtaining information on the wear condition of a vehicle braking system of the invention;

FIG. 6A shows, by means of a block diagram, an embodiment of a possible control structure which can be adapted based on the output of a control adaptation block in FIG. 5;

FIG. 7 shows, by means of a first flowchart, details an embodiment of the method in FIG. 6 if an estimation of coefficients, performed during vehicle operation, is of the recursive type;

FIG. 8 shows, by means of a second flowchart, details of an embodiment of the method in FIG. 6 if an estimation of coefficients, performed during vehicle operation, is of the non-recursive type.

Similar or equivalent elements in the aforesaid figures are indicated by the same reference numerals.

### DESCRIPTION OF SOME PREFERRED EMBODIMENTS

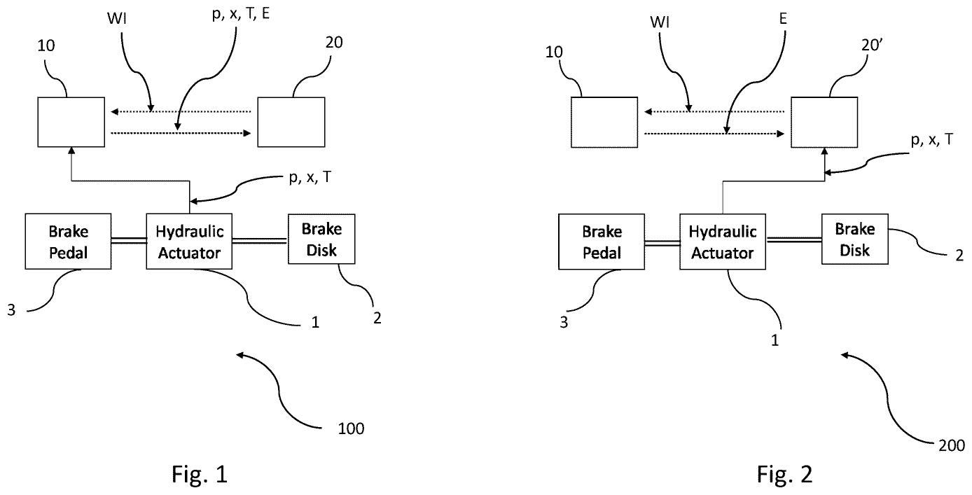

Referring to FIGS. 1-4, reference numerals 100, 200, 300, 400 indicate, as a whole, four examples of a braking system of a vehicle which implements the method 500 for obtaining information on the wear condition of the braking system according to the present invention.

For the purposes of the present description, “vehicle” means any motor vehicle or motorcycle, even of commercial type, having two, three, four, or more wheels. For example, a vehicle means a motorcar, a motorbike, a light commercial vehicle, a heavy industrial vehicle or any other vehicle which requires a braking system to reduce the speed of the moving parts.

Moreover, a “braking system” means a set of all the components (from mechanical and/or electric or electronic components to the brake fluid) which contribute to generating the service braking of a vehicle.

In more detail, the braking system 100, 200, 300 in FIGS. 1, 2, 3 employs a hydraulic actuator 1 of the brake disc 2. Such a hydraulic actuator is the brake master cylinder 1 actuated by the brake pedal 3.

The braking system 400 in FIG. 4 employs an electro-hydraulic actuator 4 of the disc brake 2. In such a system 400, a brake master cylinder is actuated by the electro-hydraulic actuator 4 according to the brake-by-wire (BBW) technology.

Referring to the example in FIG. 1, the system 100 comprises a vehicle control unit 10 (VCU), connected to the hydraulic actuator 1 of the disc brake 2, and an electronic control unit 20 (ECU) of the braking system. In particular, such an electronic control unit 20 is configured to perform the processing that implements the method of the invention and is only provided with communication interfaces.

The vehicle control unit 10 is configured to send data representative of a measurement of the pressure p of the brake master cylinder, a measurement of the stroke x of the brake master cylinder, and possibly also a measurement of the brake fluid temperature T to the aforesaid electronic control unit 20, e.g., through a CAN-type communication interface.

Such data p, x and T are provided to the vehicle control unit 10 by associated sensors of the brake master cylinder 1 operated by the brake pedal 3.

Moreover, the vehicle control unit 10 is configured to send an enabling signal E to the aforesaid electronic control unit 20, again through the communication interface, e.g., of the CAN type, to start the aforesaid processing by such a control unit 20.

Following the aforesaid processing, the vehicle control unit 10 is configured to receive, from the electronic control unit 20, again through the CAN-type communication interface, first information or wear index WI representative of the wear condition of the friction material 100 of the braking system.

Referring to the example in FIG. 2, the system 200 comprises a vehicle control unit 10 and a first electronic control unit 20′ of the braking system which is different from the electronic control unit 20 of the system 100. In particular, such a first electronic control unit 20′ is connected to the hydraulic actuator 1 of the disc brake 2 and is provided with both communication interfaces and sensor interfaces. The first electronic control unit 20′ is configured to perform the processing that implements the method of the invention.

In this second example, the vehicle control unit 10 is configured to send only one enabling signal E to the aforesaid first electronic control unit 20′, e.g., through a communication interface of the CAN type, to initiate the aforesaid processing by the first electronic control unit 20′.

The first electronic control unit 20′ is configured to receive the data representative of a measurement of the pressure p of the brake master cylinder, a measurement of the stroke x of the brake master cylinder, and possibly also a measurement of the brake fluid temperature T directly from the associated sensors of the brake master cylinder 1 actuated by the brake pedal 3.

Following the aforesaid processing, the vehicle control unit 10 is configured to receive, from the first electronic control unit 20 again through the communication interface of the CAN type, first information WI or wear index representative of the wear condition of the friction material of the braking system 200.

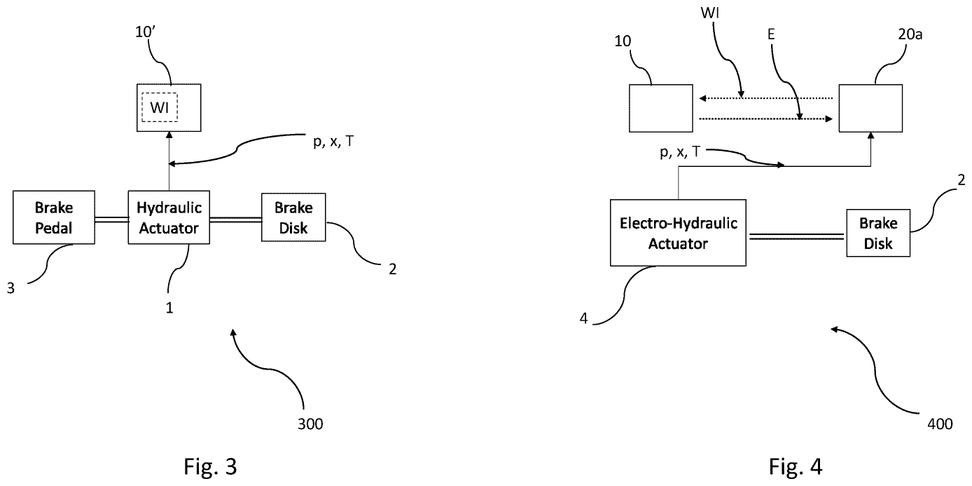

Referring to the example in FIG. 3, the system 300 comprises only a first vehicle control unit 10′ connected to the hydraulic actuator 1 of the disc brake 2 and provided with sensor interfaces. Such a first vehicle control unit 10′ is configured to perform the processing that implements the method of the invention. In other words, the functions delegated to the dedicated electronic control unit 20, 20′ in the systems 100, 200 are autonomously performed by the first vehicle control unit 10′ in the system 300.

In this third example, such a first vehicle control unit 10′ is configured to receive data representative of a measurement of the pressure p of the brake master cylinder, a measurement of the stroke x of the brake master cylinder, and possibly also a measurement of the brake fluid temperature T directly from the associated sensors of the brake master cylinder 1 actuated by the brake pedal 3 to generate the first information WI, or wear index, representative of the wear condition of the friction material of the braking system 300.

Referring to the example in FIG. 4, the system 400 comprises a vehicle control unit 10, similar to that described with reference to the systems 100, 200, and a respective electronic control unit 20a of the BBW-type braking system connected to the electro-hydraulic actuator 4 of the disc brake 2. In particular, such a BBW electronic control unit 20a is configured to perform the processing that implements the method of the invention and is provided with both communication interfaces and sensor interfaces.

In particular, the vehicle control unit 10 is configured to send only one enabling signal E to the electronic control unit 20a, e.g., through a communication interface of the CAN type, to initiate the aforesaid processing by such an electronic control unit 20a of the BBW type.

In an embodiment, the enabling signal E from the unit 10 could be assimilated to a braking signal provided as input to the electro-hydraulic actuator 4. In other words, the step of processing by the BBW unit 20a could be initiated independently of the vehicle control unit 10.

Such a BBW electronic control unit 20a is configured to receive data representative of a measurement of the pressure p of the brake master cylinder, a measurement of the stroke x of the brake master cylinder, and possibly also a measurement of the brake fluid temperature T directly from the sensors associated with the electro-hydraulic actuator 4 of the disc brake 2.

Following the aforesaid processing, the vehicle control unit 10 is configured to receive, from the electronic control unit 20a of the BBW type, again through the CAN-type communication interface, first information or wear index WI representative of the wear condition of the friction material of the braking system 400.

Note that in this embodiment, only the first information indicative of the wear index WI is sent as output to the vehicle control unit 10. The second information, related to the control adaptation, remains embedded in the electronic control unit 20a of the BBW type, where the control of actuator 4 is performed.

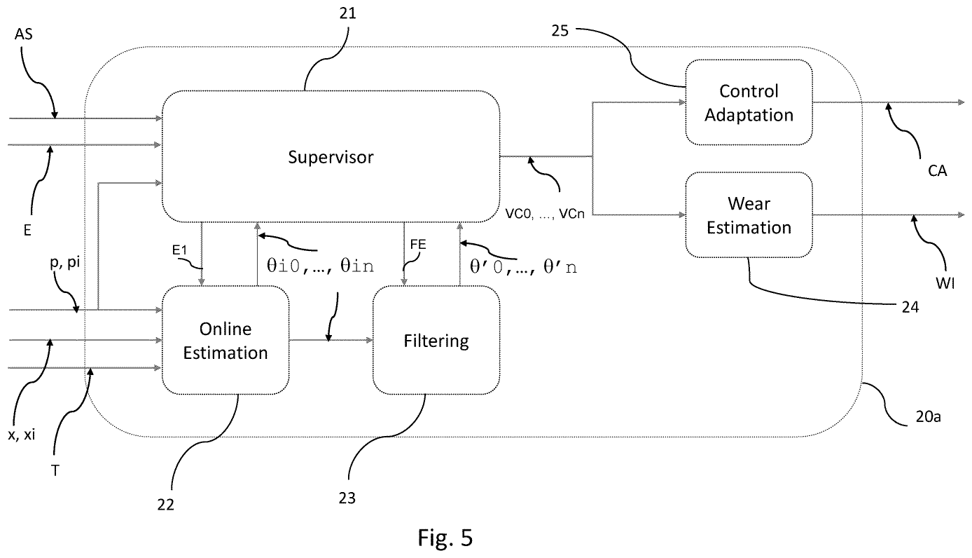

A particular embodiment of the functions of the invention implemented by the electronic control unit 20a of the braking system 400 of a vehicle, which employs electro-hydraulic (BBW) actuators, is described with reference to the block diagram in FIG. 5.

In particular, such an electronic control unit 20a comprises an estimation (Online Estimation) block 22 configured to receive as input the representative data of a measurement of the pressure p of the brake master cylinder, a measurement of the stroke x of the brake master cylinder, and possibly also a measurement of the brake fluid temperature T associated with a braking maneuver, to calculate the “best” coefficients of a specific function f, e.g., with a parabolic trend, which characterizes the plant model of the braking system.

In particular, as will be better explained below, the estimation block 22 provides a main block or supervisor block 21 with the estimated coefficients θi0, . . . , θin of the plant model following the reception of an estimation enabling signal E1 sent by such a supervisor block 21.

Note that according to the specific plant model and the minimized merit function for obtaining the best coefficients, two implementations of the estimation performed by block 22 are possible: a recursive solution and a non-recursive solution.

In the case of recursive solution, the values of the coefficients of parabola f are updated at each sampling of pressure p, stroke x and possibly temperature T within a braking detection time interval.

In the case of non-recursive solution, the values of the coefficients of parabola f are calculated at the end of the braking maneuver based on the recorded data set.

Note that the algorithms employed in both the recursive solution and the non-recursive solution belong to the prior art. Moreover, in both cases the observation window is the time duration of the braking event, indeed in the recursive case, the values of the coefficients at the end of the braking action are the same as those obtained in the non-recursive case. The difference between the two solutions is in that the recursive solution requires memory resources of a prefixed size from the processing unit 20a, while the non-recursive solution can require a larger amount of memory since it is required to store the entire braking event to then process it, because the duration of the braking event itself is not known in advance.

For example, by employing the recursive least squares algorithm, one of the possible embodiments of the function f of the plant model can be expressed with the parabola:

$$p = {θ}_{0} + {θ}_{1} * x + {θ}_{2} * {x}^{2} \qquad ( 4 )$$

In the case of more complex models and/or constraints, only non-recursive algorithms are employable.

Again with reference to FIG. 5, the electronic control unit 20a further comprises a filtering block 23 configured to receive the estimated coefficients θi0, . . . , θin as input from the estimation block 22 to provide filtered coefficients θ′0, . . . , θ′n of the plant model to the supervisor block 21 following the reception of a respective filtering enabling signal FE.

The filtering block 23 is configured to allow averaging the results of each braking maneuver.

Moreover, in order to obtain a smooth estimation of the plant model in the presence of wear, such a block allows taking into consideration temperature effects, if this is not considered as input data, and knock-off phenomena.

As known, knock-off phenomena are phenomena in which the pistons fall back from their “nominal” position, e.g., because of vibrations due to passing over curbs during a race. As a consequence, at the next braking action, the actuator must use more stroke to bring the pads into contact with the discs, resulting in a significantly different characteristic of the plant in the respective braking event.

In an embodiment, such a filtering block 23 is a low-pass filter in the braking maneuver domain, e.g., a first-order linear filter, which can be expressed by the equation:

$$y ( k + 1 ) = alpha * y ( k ) + ( 1 - alpha ) ⋆ u ( k ) \qquad ( 5 )$$

where u(k) is the input to the filter, i.e., the new value of the coefficient of the characteristic, and y(k) is the output of the filter. The alpha parameter determines the filtering level: alpha=0 no filtering, alpha=1 maximum filtering.

The supervisor block 21 is configured to manage the entire function. Such a supervisor block 21 is configured to receive as input the enabling signal E mentioned above which starts the processing. Moreover, limited to the braking system 400, the supervisor block 21 is configured to receive an input signal AS representative of the operating condition of the actuator 4.

Moreover, the supervisor block 21 is configured to receive the representative data of a measurement of the brake master cylinder pressure p as input and enable said estimation block 22 and filtering block 23 by means of the estimation enabling E1 and filtering enabling FE signals, respectively.

Moreover, based on the processing performed, the supervisor block 21 is configured to generate and provide validated coefficients VC0, . . . , VCn as output to a wear estimation block 24 and a control adaptation block 25.

In greater detail, the wear estimation block 24 is configured to receive as input the validated coefficients VC0, . . . , VCn of the plant model from the supervisor block 21 and calculate first information or wear index WI taking into consideration the wear of the friction material.

The control adaptation block 25 is configured to receive validated coefficients VC0, . . . , VCn as input and update, by means of second information or control adaptation CA, the parameters/structure of the BBW electronic control unit 20a in order to keep the performance of the braking system 400 constant despite wear.

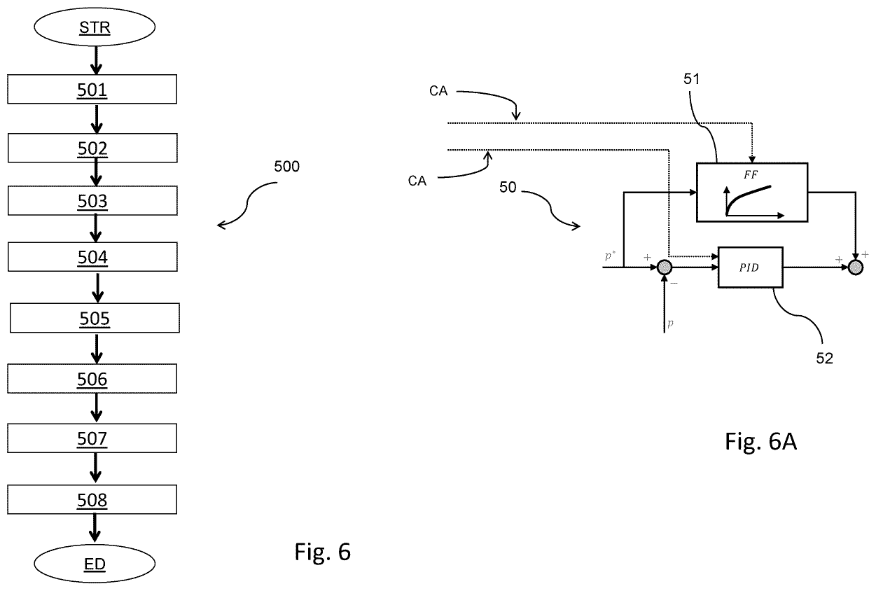

Referring to FIG. 6, reference numeral 500 indicates, as a whole, a general example of the method for obtaining information on the wear condition of a braking system 100, 200, 300, 400 of a vehicle according to the invention.

The method in FIG. 6 starts with a symbolic start step “STR” and ends with a symbolic end step “ED”.

The aforesaid braking system 100, 200, 300, 400 of the vehicle comprises:
at least one hydraulic 1, 3 or electro-hydraulic 4 actuator of a disc brake 2,
at least one electronic processing unit 10, 10′, 20, 20′, 20a connected to such at least one hydraulic 1, 3 or electro-hydraulic 4 actuator to receive data representative of a measurement of the pressure p of the brake master cylinder and a measurement of the stroke x of the brake master cylinder actuated by such an actuator during a braking detection time interval associated with each braking event.

The method 500 comprises a step in which a parametric function f representative of a current condition of the braking system 100, 200, 300, 400 of the vehicle is provided 501 to at least one electronic processing unit 10, 10′, 20, 20′, 20a. Such a parametric function f is adapted to describe a relationship between the stroke x of the brake master cylinder and the braking pressure p applied by the brake master cylinder, as a function of one or more coefficients θ0, θ1, . . . , θn as shown, for example, in equation (4).

The method 500 further comprises a step of detecting 502, by a functional supervisor block 21 of the at least one electronic processing unit 10, 10′, 20, 20′, 20a, one or more braking samples in a braking detection time interval. This allows enabling an estimation block 22 of the at least one electronic processing unit 10, 10′, 20, 20′, 20a following the detection of each braking sample.

The method 500 also comprises a step of receiving 503, by such an estimation block 22, a first pressure measurement pi of the brake master cylinder and a first stroke measurement xi of the brake master during each braking sample (i indicates the i-th braking sample) of the aforesaid one or more braking samples.

The method includes a step of estimating 504, by the aforesaid estimation block 22, a plurality of first coefficients θi0, . . . , θin of the parametric function f associated with each braking sample based on said first pressure measurement pi of the brake master cylinder and first stroke measurement xi of the brake master cylinder.

The method 500 then includes a step of enabling 505, by the supervisor block 21, a filtering block 23 of the at least one electronic processing unit 10, 10′, 20, 20′, 20a at the end the braking detection time interval.

Moreover, the method 500 includes a step of filtering 506, by the filtering block 23, the plurality of first coefficients θi0, θi1, . . . , θin associated with each braking sample to generate a plurality of second filtered coefficients θ′0, θ′1 . . . , θ′n provided to the supervisor block 21.

The method 500 of the invention includes validating 507, by the supervisor block 21, such second filtered coefficients θ′0, . . . , θ′n to generate validated coefficients VC0, . . . , VCn defining a first parametric f′ representative of the condition of the braking system 100, 200, 300, 400 following said braking detection time interval.

The method 500 includes sending 508 the aforesaid validated coefficients VC0, . . . , VCn to a wear estimation block 24 of the at least one electronic processing unit 10, 10′, 20, 20′, 20a to generate first information WI representative of a wear condition of the friction material of the braking system 100, 200, 300, 400.

In an embodiment, the first information WI representative of a wear condition of the friction material of the braking system 100, 200, 300, 400 is a predefined function g calculated on said validated coefficients VC0, . . . , VCn based on the equation WI=g(VC0, . . . , VCn).

In a particular embodiment of the method 500, the aforesaid step of receiving 503 further comprises, in addition, the step of receiving, by the estimation block 22, a measurement of the temperature T of the brake fluid. In this case, the parametric function f is adapted to describe a relationship between the stroke x of the brake master cylinder and the temperature T of the brake fluid with the braking pressure p applied by the brake master cylinder.

In a further embodiment, the method 500 further comprises a step of sending the validated coefficients VC0, . . . , VCn to a control adaptation block 25 of the at least one electronic processing unit 20a to generate second information CA used, by the at least one electronic processing unit 20a, to modify one or more control parameters.

In particular, such one or more control parameters are configured to condition a value of current pressure p of the brake master cylinder. For example, such a pressure is modified to be equal to a value of reference pressure p* based on a control scheme 50, shown in FIG. 6A, comprising a feed-forward, FF, block 51 on a first open-loop branch of the control scheme 50 and a proportional integral derivative, PID, block 52 on a second feedback branch of the control scheme 50. Such a FF block 51 is updated based on the second information CA, generated according to the validated VC0, . . . , VCn. The gains of the PID block 52 are programmed based on the second information CA, generated according to the aforesaid validated coefficients VC0, . . . , VCn. Note that such second information CA is representative of the mode with which the parameters of the curve affect the specific control block, as a function of the contents of the adaptation control block 25.

In a further embodiment, the step of filtering 506 is performed by employing a low-pass filter in the braking maneuver domain, in particular a first-order linear filter.

In a further embodiment, the aforesaid step of detecting 502 comprises a step of detecting a start instant and an end instant of the braking detection time interval. The step of estimating 504 a plurality of first coefficients θi0, . . . , θin comprises a step of executing a recursive estimation algorithm between the aforesaid start instant and end instant of the braking detection time interval.

In a further embodiment, in relation to the non-recursive case, the step of detecting 502 still comprises a step of detecting a start instant and an end instant of such a braking detection time interval and storing each instant of such a braking detection time interval. However, unlike the recursive case described above, such a step of estimating 504 a plurality of first coefficients θi0, . . . , Gin comprises a step of executing a non-recursive estimation algorithm after the end instant of the braking detection time interval.

In greater detail, the step of detecting a start instant of the braking detection time interval comprises a step of detecting a braking pressure p applied by the brake master cylinder greater than a preset value of threshold pressure pa. The step of detecting an end instant of the braking detection interval comprises a step of detecting a braking pressure p applied by the brake master cylinder less than or equal to the preset value of threshold pressure pa.

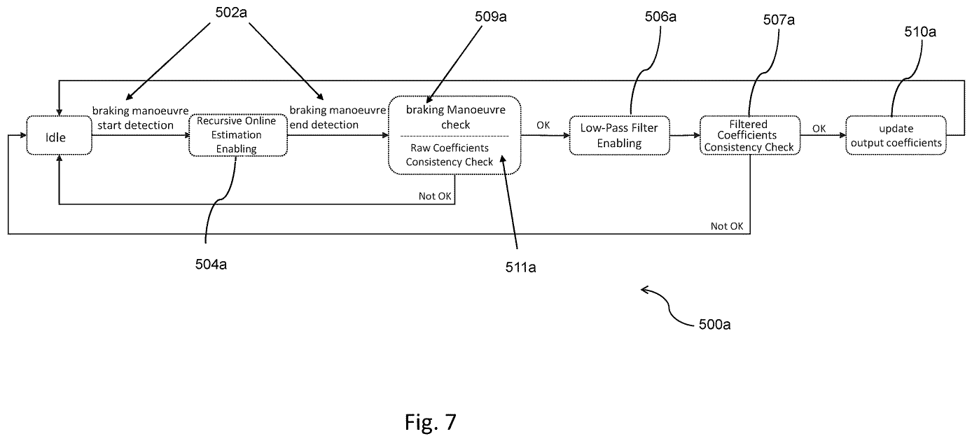

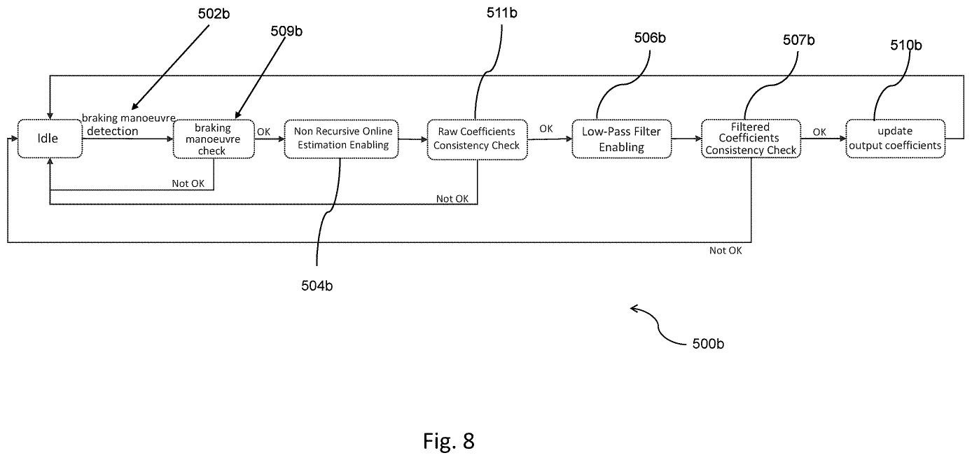

Referring to FIGS. 7 and 8, there are described below, with a first 500a and a second 500b flowchart, details of an embodiment of the method 500 of the invention in FIG. 6 if an estimation of the coefficients by the electronic processing unit 10′, 20, 20′, 20a, performed during vehicle operation, is of recursive or non-recursive type, respectively.

Starting from an idle condition, in both embodiments there is an appropriate step of detecting 502a (braking maneuver start/end detection), 502b (braking maneuver detection) of the braking maneuver to select the right data set for the estimation problem to be performed.

In the case of recursive estimation 504a (Recursive Online Estimation Enabling), carried out during the vehicle operation, such a step of detecting 502a provides for the estimation algorithm to be running between the braking maneuver start detection and the braking maneuver end detection.

In the case of non-recursive estimation 504b (Non Recursive Online Estimation Enabling), carried out during the vehicle operation, such a step of detecting 502b (braking maneuver detection) provides for the entire braking maneuver to be detected and stored, with related check (braking maneuver check) 509b, before the coefficient estimation 504b.

In both cases, as disclosed above, an example of detection of a start instant of the braking detection time interval includes a step of detecting a braking pressure p applied by the brake master cylinder greater than a preset value of threshold pressure pa. The detection of an end instant of the braking detection interval includes a step of detecting a braking pressure p applied by the brake master cylinder less than or equal to the preset value of threshold pressure pa.

At the end of each detected braking maneuver, an appropriate function verifies 509a, 509b the consistency of the maneuver.

In the case of estimation of recursive-type coefficients, such a consistency verification 509a is a post-hoc check to accept the results of the estimation 504a.

In the case of estimation of non-recursive coefficients, such a consistency estimation 509b allows eliminating unnecessary braking maneuvers before calculating 504b the “best” coefficients referring to the braking action itself.

In particular, in the case of recursive type estimation, the supervisor block 21 collects the input data, receives the f-function parameters estimated by the estimation block 22, evaluates the reliability thereof by discarding poorly significant braking events in the block 509a and the parameters not physically acceptable in the block 511a (raw coefficients consistency check). In the case of non-recursive type estimation, the supervisor block 21 receives the input data, evaluates the significant braking events in the block 509b, receives the possible f-function parameter estimation from the estimation block 22, evaluates the reliability thereof by discarding the parameters not physically acceptable in the block 511b (raw coefficients consistency check).

In an embodiment, such a step of verifying 509a, 509b the braking consistency comprises the steps of checking that:
a maximum pressure pₘₐₓ applied by the brake master cylinder is greater than or equal to a preset pressure value;
a duration of the braking detection time interval is greater than a reference time interval.

In other words, such a function allows accepting only braking events in which a pressure greater than a given threshold value is applied or even braking events with a duration greater than a given threshold value (braking maneuver check), so as to discard “false braking events” or insignificant braking events.

Downstream of the step 504a, 504b of both recursive and non-recursive estimation, a consistency verification 511a, 511b on the raw coefficient values is performed by the supervisor block 21 to decide whether to accept such values or not.

If such a consistency verification 511a, 511b is successful, the supervisor block 21 continues with a low-pass filtering 506a, 506b of such raw coefficients (low-pass filter enabling).

Downstream of the low-pass filtering blocks 506a, 506b, a consistency verification or validation 507a, 507b (filtered coefficient consistency check) is performed by the supervisor block 21, on the filtered coefficient values to decide whether to accept such values or not.

In the recursive solution, the first check 507a is performed together with that of the first braking maneuver 502a.

In an embodiment, in the case of the plant model represented by a parabola in equation (4), such a check includes:
convexity of the parabola: θ₂>0
position of the vertex of the parabola: pvert(θ)≤p+.

Next, in both the recursive and non-recursive cases, it is possible to define 510a, 510b (update output coefficients) a first parametric function f′ updated according to the validated coefficients VC0, . . . , VCn.

The present invention also relates to a braking system 100, 200, 300, 400 of a vehicle comprising:
at least one hydraulic 1, 3 or electro-hydraulic 4 actuator of a disc brake 2,
at least one electronic processing unit 10, 10′, 20, 20′, 20a connected to said at least one hydraulic 1, 3 or electro-hydraulic 4 actuator to receive data representative of a measurement of the pressure p of the brake master cylinder and a measurement of the stroke x of the brake master cylinder actuated by said actuator during a braking detection time interval associated with each braking event, where the at least one electronic processing unit 10, 10′, 20, 20′, 20a is configured to perform the method of the present invention.

The present invention also relates to a computer program comprising an application code loaded on a memory and executable by at least one electronic processing unit 10, 10′, 20, 20′, 20a of a braking system 100, 200, 300, 400 of a vehicle to implement the method of the present invention.

Although the invention explicitly refers to a vehicle braking system of the type employing hydraulic actuators or electro-hydraulic actuators, the same solution can be implemented in a braking system of pneumatic or electro-pneumatic type. Moreover, the same solution could be applied to an electro-mechanical system, where pressure is replaced by force.

In order to meet contingent needs, those skilled in the art may make changes and adaptations to the embodiments of the method described above or can replace elements with others which are functionally equivalent, without departing from the scope of the following claims. Each of the features described above as belonging to a possible embodiment can be implemented irrespective of the other embodiments described.

1-13. (canceled)

14. A method for obtaining information on the wear condition of a braking system of a vehicle, said braking system comprising:
at least one hydraulic or electro-hydraulic actuator of a disc brake,
at least one electronic processing unit connected to said at least one hydraulic or electro-hydraulic actuator for receiving data representative of a measurement of the pressure of the brake master cylinder and a measurement of the stroke of the brake master cylinder actuated by said actuator during a braking detection time interval associated with each braking event;
the method comprising the steps of:
providing, to said at least one electronic processing unit, a parametric function representative of a current condition of the braking system of the vehicle, said parametric function being adapted to describe a relationship between the stroke of the brake master cylinder and the braking pressure applied by the brake master cylinder, as a function of one or more coefficients;
detecting, by a supervisor block of the at least one electronic processing unit one or more braking samples in a braking detection time interval, for enabling an estimation block of said at least one electronic processing unit following the detection of each braking sample;
receiving, by said estimation block, a first pressure measurement of the brake master cylinder and a first stroke measurement of the brake master cylinder during each braking sample of said one or more braking samples;
estimating, by said estimation block, a plurality of first coefficients of said parametric function associated with each braking sample based on said first pressure measurement of the brake master cylinder and first stroke measurement of the brake master cylinder;
enabling, by the supervisor block, a filtering block of said at least one electronic processing unit at the end of the braking detection time interval;
filtering, by the filtering block, the plurality of first coefficients associated with each braking sample to generate a plurality of second filtered coefficients provided to the supervisor block;
validating, by the supervisor block, said second filtered coefficients to generate validated coefficients defining a first parametric function representative of the condition of the braking system following said braking detection time interval;
sending said validated coefficients to a wear estimation block of the at least one electronic processing unit to generate first information representative of a wear condition of the friction material of the braking system.

15. The method for obtaining information on the wear condition of a braking system according to claim 14, wherein said first information representative of a wear condition of the friction material of the braking system is a predefined function calculated on said validated coefficients.

16. The method for obtaining information on the wear condition of a braking system according to claim 14, wherein said step of receiving further comprises the step of also receiving, by the estimation block, a measurement of the temperature of the brake fluid, said parametric function being adapted to describe a relationship between the stroke of the brake master cylinder and the temperature of the brake fluid with the braking pressure applied by the brake master cylinder.

17. The method for obtaining information on the wear condition of a braking system according to claim 14, further comprising a step of sending said validated coefficients to a control adaptation block of the at least one electronic processing unit to generate second information employed by the at least one electronic processing unit for changing one or more parameters controlled by said electronic processing unit.

18. The method for obtaining information on the wear condition of a braking system according to claim 17, wherein said parameter controlled by the at least one electronic processing unit is a value of current pressure of the brake master cylinder, said pressure being modified to be equal to a value of reference pressure based on a control scheme comprising a feed-forward, FF, block on a first open-loop branch of the control scheme and a proportional integral derivative, PID, block on a second feedback branch of the control scheme,
said FF block being updated based on said second information generated according to the validated coefficients and the gains of the PID block being programmed based on said second information generated according to said validated coefficients.

19. The method for obtaining information on the wear condition of a braking system according to claim 14, wherein said step of filtering is performed by employing a low-pass filter in the braking maneuver domain, in particular a first-order linear filter.

20. The method for obtaining information on the wear condition of a braking system according to claim 14, wherein:
said step of detecting comprises a step of detecting a start instant and an end instant of said braking detection time interval;
said step of estimating a plurality of first coefficients comprising a step of executing a recursive estimation algorithm between said start instant and end instant of the braking detection time interval.

21. The method for obtaining information on the wear condition of a braking system according to claim 14, wherein:
said step of detecting comprises a step of detecting a start instant and an end instant of said braking detection time interval and storing each instant of said braking detection time interval;
said step of estimating a plurality of first coefficients comprising a step of executing a non-recursive estimation algorithm after the end instant of the braking detection time interval.

22. The method for obtaining information on the wear condition of a braking system according to claim 20, wherein:
the step of detecting a start instant of the braking detection time interval comprises a step of detecting a braking pressure applied by the brake master cylinder greater than a preset value of pressure;
the step of detecting an end instant of the braking detection interval comprises a step of detecting a braking pressure applied by the brake master cylinder less than or equal to the preset value of pressure.

23. The method for obtaining information on the wear condition of a braking system according to claim 14, further comprising a step of verifying the braking consistency, said step of verifying comprising the steps of verifying that:
a maximum pressure applied by the brake master cylinder is greater than or equal to a preset threshold pressure value;
a duration of the braking detection time interval is greater than a reference time interval.

24. The method for obtaining information on the wear condition of a braking system according to claim 14, wherein said parametric function and said first parametric function have a parabola-like pattern.

25. A braking system of a vehicle comprising:
at least one hydraulic or electro-hydraulic actuator of a disc brake,
at least one electronic processing unit connected to said at least one hydraulic or electro-hydraulic actuator for receiving data representative of a measurement of the pressure of the brake master cylinder and a measurement of the stroke of the brake master cylinder actuated by said actuator during a braking detection time interval associated with each braking event,
said at least one electronic processing unit being configured to perform the method according to claim 14.

26. A computer program comprising an application code loaded on a memory and executable by an electronic control unit of a braking system of a vehicle to implement the method according to claim 14.
